(19) United States
(12) Patent Application Publication
(10) Pub. No.: US 2009/0126202 A1
(43) Pub. Date: May 21, 2009

(54) SCISSORS HAVING HANDLES WITH FLEXIBLE RINGS

(75) Inventor: Daniel RACAMIER, La Balme De Sillingy (FR)

Correspondence Address: CANTOR COLBURN, LLP, 20 Church Street, 22nd Floor, Hartford, CT, 06103, US

(73) Assignee: MAPED, Argonay (FR)

(21) Appl. No.: 12/269,304

(22) Filed: Nov. 12, 2008

(30) Foreign Application Priority Data
Nov. 12, 2007 (FR) 07.07914

(51) Int. Cl. B26B 13/00

(52) U.S. Cl. 30/232; 30/244

(57) ABSTRACT

Each arm (1) of the scissors comprises a handle (5) with a rigid outer ring (8) and an inner ring (9) made of a flexible and elastically deformable material. The flexible inner ring (9) comprises a part (10) resembling a length of tube and receiving one or more of the user's fingers, and a thin membrane-like part (11) which connects the preceding part (10) to the rigid outer ring (8) of the handle (5). This configuration is both comfortable and firm.

### CROSS-REFERENCE TO RELATED APPLICATIONS

This application is related to and claims priority to French Patent Application 07 07914, filed on Nov. 12, 2007, the entire contents of which are incorporated by reference herein.

### FIELD

The present invention relates in general terms to scissors, for all uses. More specifically, the invention relates to scissors whose handles are provided with flexible rings, the presence of which is intended to make the scissors more comfortable and more ergonomic.

### BACKGROUND

As is well known, all scissors consist of two arms held together by a pivot pin. Each arm comprises a cutting blade projecting from one side of the pivot pin, and a handle projecting essentially from the other side of this pin. The two handles, located side by side, usually each form a hole or ring able to take one or more of the user's fingers.

In the simplest design, the scissor handles are made of the same material—and in particular the same metal—as the blades. The handles may also be made of a rigid synthetic material overmoulded around the rear of the metal blades.

There are also diverse forms of scissors in which the handles are each built from two separate materials, specifically an outer ring of rigid synthetic material, and an inner ring of a flexible and elastically deformable material, offering a pleasanter feel and a certain adaptability to the morphology and position of the fingers of the user.

Patent documents GB 207968, FR 1095789, U.S. Pat. No. 5,987,757, EP 0607223 and EP 0827715 may be referred to here as examples of such scissors having handles with flexible inner rings.

The products disclosed by those documents have inner rings that are flexible but fixed, having a smooth surface, and being directly attached to the rest of the handle. Despite the improvement already procured by such flexible rings, it is still difficult to find a good compromise between comfort on the one hand and firmness on the other: a ring made of too soft a material is good for comfort but is less firm, while conversely a ring made of a less flexible material is firmer but less comfortable. In general, attaching the flexible ring directly to the rigid outer ring of the handle negates most of the first ring's deformability, despite its intrinsic flexibility.

The problem is partly solved by scissors sold by the Applicant under the name ZENOA (registered trade mark). These are scissors with handles comprising flexible rings which have locally a series of parallel ribs to increase the deformability of these rings.

Other known approaches consist in adapting the scissors to the morphology and position of the user's hand, by having at least one of the handles mounted on a pivot, or alternatively having an inner ring of the handle mounted movably, for example on a ball joint. Examples of such approaches may be found in patent documents FR 2 419 804, FR 2 749 208, DE 3 928 859, DE 8 801 248 U and EP 1 693 167.

These latter approaches generally result in too much freedom of movement of the handle or of the movable ring while introducing an expensive and more or less cumbersome mechanical complication, typically by the addition of a joint or pivot. What is more, and especially when in use, the positioning or orientation of a handle mounted on a joint may be incorrect, which is the cause of poor transmission of the manual effort applied by the user and thus necessitates a greater manual effort by the user. These “mechanical” approaches also introduce play and therefore imprecisions and noises, while also creating gaps where dirt can become lodged.

### BRIEF DESCRIPTION

It is an object of the present invention to solve the problems set forth above, and its object is therefore to provide, for scissors of the type considered here, a solution that offers at the same time comfort and adequate firmness, in order to satisfy the greatest number of users, while maintaining a simple compact and inexpensive structure.

To this end, the subject of the invention is scissors with flexible rings, in other words scissors consisting of two arms held together by a pivot pin, each arm comprising a cutting blade projecting from one side of the pivot pin, and a handle projecting essentially from the other side of this pivot, and each handle comprising a rigid outer ring and an inner ring made of a flexible and elastically deformable material, these scissors being essentially characterized by the fact that the inner ring of flexible and elastically deformable material comprises a first part or inner part resembling a length of tube designed to receive one or more of the user's fingers, and a thin membrane-like second part situated in a plane approximately perpendicular to the axis of the first part, all the way around the latter, connecting said first part directly or indirectly to the rigid outer ring of the handle.

In one embodiment of the invention, the membrane-like thin part of the flexible inner ring connects the inner part, resembling a length of tube, to an outer annular part of this flexible ring, by which outer annular part said flexible ring is fixed to the rigid outer ring of the handle.

The attachment of the flexible inner ring to the rigid outer ring, typically via the outer annular part of the flexible ring may be done by a variety of appropriate methods, such as overmoulding, twin-shot injection moulding, co-injection moulding, welding, especially by ultrasound, adhesive bonding, and mechanical assembly such as male/female engagement or snap-fastening, etc.

The present invention thus provides a solution which, by means of the membrane-like and therefore thin intermediate part, permits a multidirectional orientation of the inner tubular part of the flexible ring receiving one or more fingers, while imposing a certain directionality, with a tendency to return to a middle position. The proposed solution is also very simple and cheap, the recommended configuration for the flexible rings being obtained directly by the moulding operation, without mechanical complications.

More specifically, in the use of the scissors having handles with flexible rings according to the invention, when the finger or fingers are positioned on the inner part, the pressure exerted by the finger or fingers causes the membrane to deform elastically because of the positioning imposed on the inner part. The compressed and/or folded membrane thus acts temporarily as a compression spring, while the part in contact with the user's finger or fingers is able to orientate itself in any direction in space (within certain limits). This gives the rings great adaptability to different users, so as to suit the thickness of their fingers and/or the way in which they hold the scissors when cutting, and it also facilitates the introduction of the fingers into the rings. When the scissors are finished with, the fingers are withdrawn from the rings and the pressure on the inner parts is terminated, so that these parts return automatically to their initial position because of the elasticity of the membrane.

For good morphological adaptability and optimized deformability, the inner part of the flexible ring, resembling a length of tube, advantageously has a height that is variable along its circumference.

The thin membrane-like part of the flexible ring may comprise perforations or interruptions distributed all the way around its circumference or around part of this circumference, in order at least locally to provide greater deformability to this membrane when the membrane is stressed.

### BRIEF DESCRIPTION OF THE FIGURES

A clearer understanding of the invention will be gained from the following description, which refers to the attached diagrammatic drawing showing, by way of examples, certain embodiments of these scissors with handles having flexible rings:

FIG. 1 is a general perspective view of scissors in accordance with the present invention;

FIG. 2 shows in perspective and on a larger scale a handle for scissors in accordance with the present invention;

FIG. 3 is a transverse section through the handle seen in FIG. 2;

FIG. 4 is a front view of the flexible ring only of this handle;

FIG. 5 is a side view of this flexible ring viewed in the direction of the arrow marked F1 in FIG. 4;

FIG. 6 is another side view of the same flexible ring viewed in the direction of the arrow marked F2 in FIG. 4;

FIG. 7 is a transverse section on an enlarged scale through the flexible ring only; and

FIG. 8 is a front view of a variant of this flexible ring.

### DETAILED DESCRIPTION

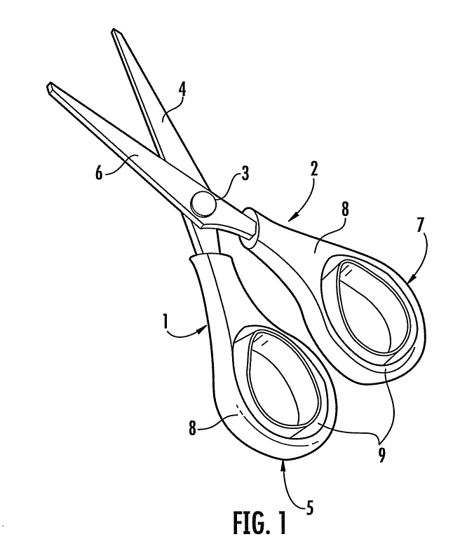

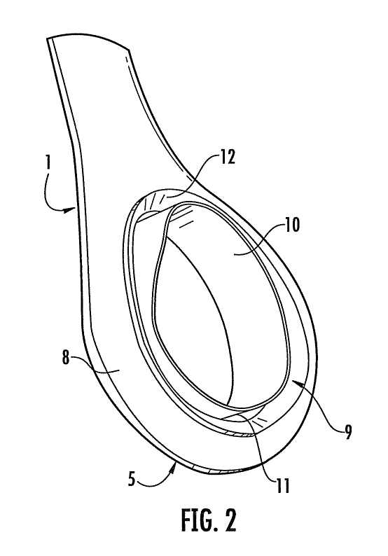

FIGS. 1 and 2 show scissors which, in a generally known manner, consist of two arms 1 and 2 held together by pivoting about a pin 3. The first arm 1 has a cutting blade 4 projecting from one side of the pivot pin 3, and a handle 5 projecting essentially from the other side of this pin 3. The second arm 2 similarly has a cutting blade 6 projecting from one side of the pivot pin 3, and a handle 7 projecting essentially from the other side of this pin 3. The two handles 5 and 7 are thus located side by side so that their user can grasp the scissors.

Each handle 5 or 7 is composed of an outer ring 8 made of a rigid synthetic material, and an inner ring 9 made of a flexible and elastically deformable synthetic material. The outer rings 8 of both handles 5 and 7 are overmoulded around the rear of the corresponding cutting blades 4 and 6, which are usually made of metal.

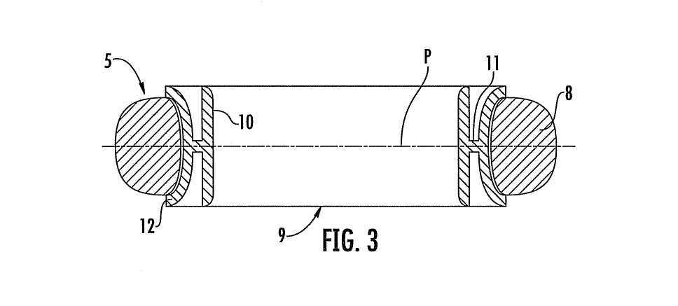

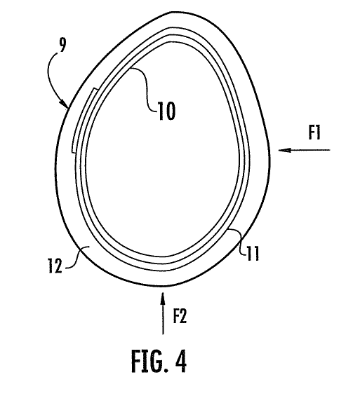

The flexible inner rings 9 have a special configuration which is illustrated (in a first embodiment) in FIGS. 3 to 7. Each flexible inner ring 9 comprises, proceeding from the inside out:
a first part or inner part 10 similar in appearance to a short length of tube;
a thin second part 11, denoted the “membrane”, which lies roughly in the mid-plane P of the first part 10, at right angles to its axis, and all the way around said first part; and
a third part or outer part 12 of annular appearance, connected to the second part 11.

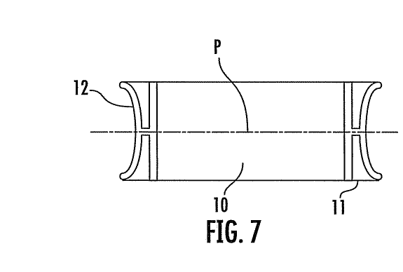

Thus, the membrane 11 connects, all the way around the circumference, the inner part 10 to the outer part 12 in what is approximately an “H” configuration (see FIGS. 3 and 7). The profile of the outer part 12 is rounded to fit the inner profile of the outer ring 8.

The outer part 12 of the flexible inner ring 9 is applied to the inner region of the outer ring 8, to which it adheres, particularly as a result of the manufacturing method employed, such as overmoulding or sandwich injection moulding.

When cutting, the user inserts his fingers into the flexible inner rings 9 of the two handles 5 and 7. More specifically, the fingers are inserted into the tubular inner parts 10 of the flexible inner rings 9. These parts 10 can then be orientated in all directions, with a corresponding elastic deformation of the membranes 11.

The scissors thus adapt to the thickness of the user's fingers and his manner of holding the scissors while cutting.

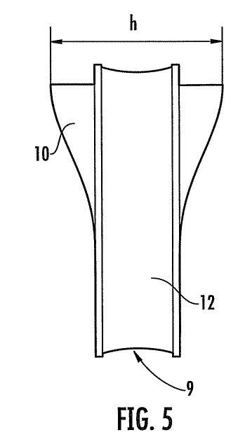

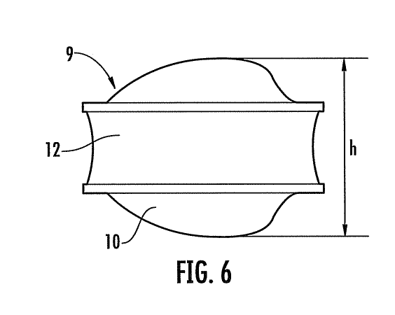

As shown particularly in FIGS. 5 and 6, the tubular inner part 10 of each flexible inner ring 9 advantageously has a height h that is variable around the circumference of the ring, especially a height that is greater in certain angular sectors, for optimized adaptation.

In the simplest embodiment, as illustrated in FIGS. 3 to 7, the membrane 11 of each flexible inner ring 9 has a continuous or uninterrupted surface all the way around the circumference of the ring 9.

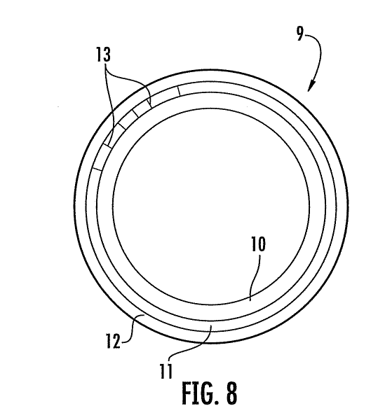

In a variant, illustrated in FIG. 8, the membrane 11 of the flexible ring 9 comprises perforations or interruptions 13 distributed all the way around its circumference or around only part of this circumference, in a particular region of the membrane 11, such as the region where the thumb presses on the scissors. Such a configuration gives greater deformability of all or part of the membrane 11 and hence an enhanced ability for the tubular inner part 10 of the flexible rings 9 to be orientated.

In all cases, when the user withdraws his fingers from the handles 5 and 7, the stress is removed from the membrane 11 which, by elastic return, settles the tubular inner part 10 back in its initial position.

The following would not constitute departures from the scope of the invention as defined in the accompanying
modifications to the detail of the shapes of the handles, and in particular of their rings, which can be of circular, oval, oblong or other shapes;
particularly as regards the flexible rings, a membrane that is not in the mid-plane of the tubular inner part but more generally in any plane perpendicular to the axis of this tubular inner part, with a certain asymmetry;
flexible rings made of any appropriate material;
connecting these flexible rings to the rigid outer rings by any suitable method such as overmoulding, twin-shot injection moulding, co-injection moulding, welding, adhesive bonding, mechanical assembly, etc.;
such scissors having flexible rings in all sizes and for all types of use, especially for home, school, office, DIY, professional or other uses.

1. Scissors having handles with flexible rings, the scissors consisting of two arms held together by a pivot pin, each arm comprising a cutting blade projecting from one side of the pivot pin, and a handle projecting essentially from the other side of the pivot pin, and each handle comprising a rigid outer ring and an inner ring made of a flexible and elastically deformable material, said scissors being characterized in that the inner ring of flexible and elastically deformable material comprises a first part or inner part resembling a length of tube, designed to receive one or more of the user's fingers, and a thin membrane-like second part situated in a plane approximately perpendicular to the axis of the first part, all the way around the latter, connecting said first part directly or indirectly to the rigid outer ring of the handle.

2. Scissors having handles with flexible rings according to claim 1, wherein the membrane-like thin part of the flexible inner ring connects the inner part, resembling a length of tube, to an outer annular part of this flexible ring, by which outer annular part said flexible ring is fixed to the rigid outer ring of the handle.

3. Scissors having handles with flexible rings according to claim 1, wherein the inner part of the flexible ring, resembling a length of tube, has a height (h) that is variable along its circumference.

4. Scissors having handles with flexible rings according to claim 1, wherein the thin membrane-like part of the flexible ring comprises perforations or interruptions distributed all the way around its circumference or around part of its circumference.
